(19) United States
(12) Patent Application Publication
(10) Pub. No.: US 2009/0041297 A1
(43) Pub. Date: Feb. 12, 2009

(54) Human detection and tracking for security applications

(75) Inventors: Zhong Zhang, Herndon, VA (US); Alan J. Lipton, Herndon, VA (US); Paul C. Brewer, Arlington, VA (US); Andrew J. Chosak, Arlington, VA (US); Niels Haering, Reston, VA (US); Gary W. Myers, Ashburn, VA (US); Peter L. Venetianer, McLean, VA (US); Weihong Yin, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/139,986

(22) Filed: May 31, 2005

(51) Int. Cl. G06K 9/00

(52) U.S. Cl. 382/103

(57) ABSTRACT

A computer-based system for performing scene content analysis for human detection and tracking may include a video input to receive a video signal; a content analysis module, coupled to the video input, to receive the video signal from the video input, and analyze scene content from the video signal and determine an event from one or more objects visible in the video signal; a data storage module to store the video signal, data related to the event, or data related to configuration and operation of the system; and a user interface module, coupled to the content analysis module, to allow a user to configure the content analysis module to provide an alert for the event, wherein, upon recognition of the event, the content analysis module produces the alert.

### BACKGROUND OF THE INVENTION

1. Field of the Invention

This invention relates to surveillance systems. Specifically, the invention relates to a video-based intelligent surveillance system that can automatically detect and track human targets in the scene under monitoring.

2. Related Art

Robust human detection and tracking is of great interest for the modem video surveillance and security applications. One concern for any residential and commercial system is a high false alarm or propensity for false alarms. Many factors may trigger a false alarm. In a home security system for example; any source of heat, sound or movement by objects or animals, such as birthday balloons or pets, or even the ornaments on a Christmas tree, may cause false alarms if they are in the detection range of a security sensor. Such false alarms may prompt a human response that significantly increases the total cost of the system. Furthermore, repeated false alarms may decrease the effectiveness of the system, which can be detrimental when real event or threat happens.

As such, the majority of false alarms need to be removed if the security system can reliably detect a human object in the scene, since it appears that non-human objects cause most false alarms. What is needed is a reliable human detection and tracking system that can not only reduce false alarms, but can also be used to perform higher level human behavior analysis, which may have wide range of potential applications, including but not limited to human counting, elderly or mentally ill surveillance, and suspicious human criminal action detection.

### SUMMARY OF THE INVENTION

The invention includes a method, a system, an apparatus, and an article of manufacture for human detection and tracking.

In embodiments, the invention uses a human detection approach with multiple cues on human objects, and a general human model. Embodiments of the invention also employ human target tracking and temporal information to further increase detection reliability.

Embodiments of the invention may also use human appearance, skin tone detection, and human motion in alternative manners. In one embodiment, face detection may use frontal or semi-frontal views of human objects as well as head image size and major facial features.

The invention, according to embodiments, includes a computer-readable medium containing software code that, when read by a machine, such as a computer, causes the computer to perform a method for video target tracking including, but not limited to, the operations: performing change detection on the input surveillance video; detecting and tracking targets; and detecting event of interest based on user defined rules.

In embodiments, a system for the invention may include a computer system including a computer-readable medium having software to operate a computer in accordance with the embodiments of the invention. In embodiments, an apparatus for the invention includes a computer including a computer-readable medium having software to operate the computer in accordance with embodiments of the invention.

In embodiments, an article of manufacture for the invention includes a computer-readable medium having software to operate a computer in accordance with embodiments of the invention.

Exemplary features and advantages of the invention, as well as the structure and operation of various embodiments of the invention, may be described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts a conceptual block diagram of an intelligent video system (IVS) system according to embodiments of the invention;

FIG. 2 depicts a conceptual block diagram of the human detection/tracking oriented content analysis module of an IVS system according to embodiments of the invention;

FIG. 3 depicts a conceptual block diagram of the human detection/tracking module according to embodiments of the invention;

FIG. 4 lists the major components in the human feature extraction module according to embodiments of the invention;

FIG. 5 depicts a conceptual block diagram of the human head detection module according to embodiments of the invention;

FIG. 6 depicts a conceptual block diagram of the human head location detection module according to embodiments of the invention;

FIG. 7 illustrates an example of target top profile according to embodiments of the invention;

FIG. 8 shows some example of detected potential head locations according to embodiments of the invention;

FIG. 9 depicts a conceptual block diagram of the elliptical head fit module according to embodiments of the invention;

FIG. 10 illustrates the method on how to find the head outline pixels according to embodiments of the invention;

FIG. 11 illustrates the definition of the fitting error of one head outline point to the estimated head model according to embodiments of the invention;

FIG. 12 depicts a conceptual block diagram of the elliptical head refine fit module according to embodiments of the invention;

FIG. 13 lists the main components of the head tracker module 406 according to embodiments of the invention;

FIG. 14 depicts a conceptual block diagram of the relative size estimator module according to embodiments of the invention;

FIG. 15 depicts a conceptual block diagram of the human shape profile extraction module according to embodiments of the invention;

FIG. 16 shows an example of human projection profile extraction and normalization according to the embodiments of the invention;

FIG. 17 depicts a conceptual block diagram of the human detection module according to embodiments of the invention;

FIG. 18 shows an example of different levels of human feature supports according to the embodiments of the invention;

FIG. 19 lists the potential human target states used by the human target detector and tracker according to the embodiments of the invention;

FIG. 20 illustrates the human target state transfer diagram according to the embodiments of the invention.

It should be understood that these figures depict embodiments of the invention. Variations of these embodiments will be apparent to persons skilled in the relevant art(s) based on the teachings contained herein. For example, the flow charts and block diagrams contained in these figures depict particular operational flows. However, the functions and steps contained in these flow charts can be performed in other sequences, as will be apparent to persons skilled in the relevant art(s) based on the teachings contained herein.

### DEFINITIONS

The following definitions are applicable throughout this disclosure, including in the above.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection. A “frame” refers to a particular image or other discrete unit within a video.

A “video camera” may refer to an apparatus for visual recording. Examples of a video camera may include one or more of the following: a video camera; a digital video camera; a color camera; a monochrome camera; a camera; a camcorder; a PC camera; a webcam; an infrared (IR) video camera; a low-light video camera; a thermal video camera; a CCTV camera; a pan, tilt, zoom (PTZ) camera; and a video sensing device. A video camera may be positioned to perform surveillance of an area of interest.

An “object” refers to an item of interest in a video. Examples of an object include: a person, a vehicle, an animal, and a physical subject.

A “target” refers to the computer's model of an object. The target is derived from the image processing, and there is a one to one correspondence between targets and objects. The target in this disclosure is particularly refers to a period of consistent computer's model for an object for a certain time duration.

A “computer” refers to any apparatus that is capable of accepting a structured input, processing the structured input according to prescribed rules, and producing results of the processing as output. The computer may include, for example: any apparatus that accepts data, processes the data in accordance with one or more stored software programs, generates results, and typically includes input, output, storage, arithmetic, logic, and control units; a computer; a general purpose computer; a supercomputer; a mainframe; a super mini-computer; a mini-computer; a workstation; a micro-computer; a server; an interactive television; a web appliance; a telecommunications device with internet access; a hybrid combination of a computer and an interactive television; a portable computer; a personal digital assistant (PDA); a portable telephone; application-specific hardware to emulate a computer and/or software; a stationary computer; a portable computer; a computer with a single processor; a computer with multiple processors, which can operate in parallel and/or not in parallel; and two or more computers connected together via a network for transmitting or receiving information between the computers, such as a distributed computer system for processing information via computers linked by a network.

A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; software programs; computer programs; and programmed logic.

A “computer system” refers to a system having a computer, where the computer comprises a computer-readable medium embodying software to operate the computer.

A “network” refers to a number of computers and associated devices that are connected by communication facilities. A network may involve permanent connections such as cables or temporary connections such as those made through telephone, wireless, or other communication links. Examples of a network may include: an internet, such as the Internet; an intranet; a local area network (LAN); a wide area network (WAN); and a combination of networks, such as an internet and an intranet.

### DETAILED DESCRIPTION OF EMBODIMENTS OF THE PRESENT INVENTION

Exemplary embodiments of the invention are described herein. While specific exemplary embodiments are discussed, it should be understood that this is done for illustration purposes only. A person skilled in the relevant art will recognize that other components and configurations can be used without parting from the spirit and scope of the invention based, at least, on the teachings provided herein.

The specific application of exemplary embodiments of the invention include but are not limited to the following: residential security surveillance; commercial security surveillance such as, for example, for retail, heath care, or warehouse; and critical infrastructure video surveillance, such as, for example, for an oil refinery, nuclear plant, port, airport and railway.

In describing the embodiments of the invention, the following guidelines are generally used, but the invention is not limited to them. One of ordinary skill in the relevant arts would appreciate the alternatives and additions to the guidelines based, at least, on the teachings provided herein.

1. A human object has a head with an upright body support at least for a certain time in the camera view. This may require that the camera is not in an overhead view and/or that the human is not always crawling.

2. A human object has limb movement when the object is moving.

3. A human size is within a certain range of the average human size.

4. A human face might be visible.

The above general human object properties are guidelines that serve as multiple cues for a human target in the scene, and different cues may have different confidences on whether the target observed is a human target. According to embodiments, the human detection on each video frame may be the combination, weighted or non-weighted, of all the cues or a subset of all cues from that frame. The human detection in the video sequence may be the global decision from the human target tracking.

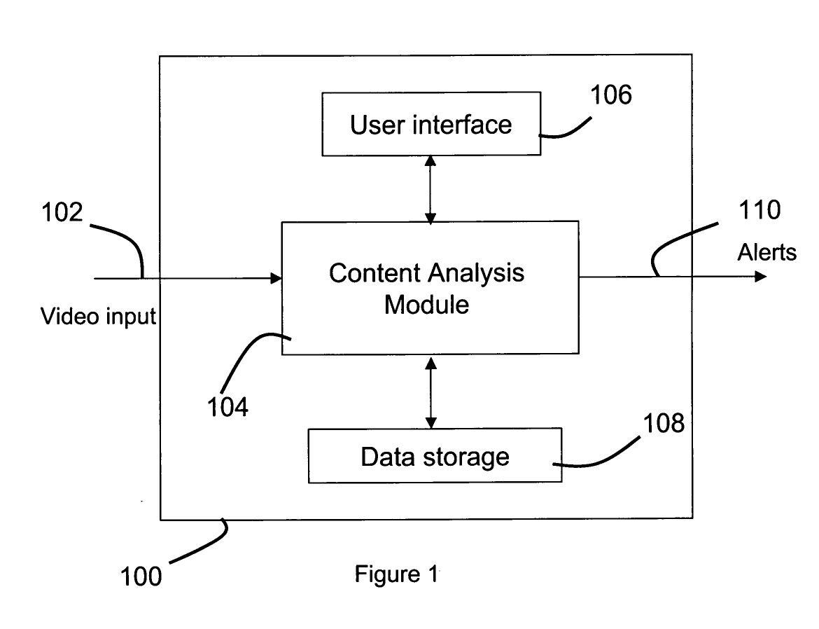

FIG. 1 depicts a conceptual block diagram of a typical IVS system 100 according to embodiments of the invention. The video input 102 may be a normal closed circuit television (CCTV) video signal or generally, a video signal from a video camera. Element 104 may be a computer having a content analysis module, which performs scene content analysis as described herein. A user can configure the system 100 and define events through the user interface 106. Once any event is detected, alerts 110 will be sent to appointed staffs with necessary information and instructions for further attention and investigations. The video data, scene context data, and other event related data will be stored in data storage 108 for later forensic analysis. This embodiment of invention focuses on one particular capability of the content analysis module 104, namely human detection and tracking. Alerts may be generated whenever a human target is detected and tracked in the video input 102.

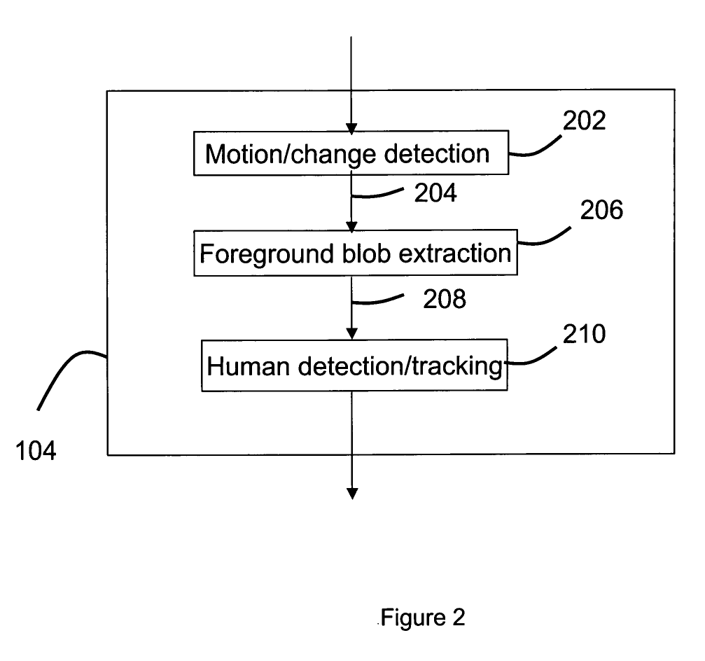

FIG. 2 depicts a block diagram of an operational embodiment of human detection/tracking by the content analysis module 104 according to embodiments of the invention. First, the system may use a motion and change detection module 202 to separate foreground from background 202, and the output of this module may be the foreground mask for each frame. Next, the foreground regions may be divided into separate blobs 208 by the blob extraction module 206, and these blobs are the observations of the targets at each timestamp. Human detection/tracking module 210 may detect and track each human target in the video, and send out alert 110 when there is human in the scene.

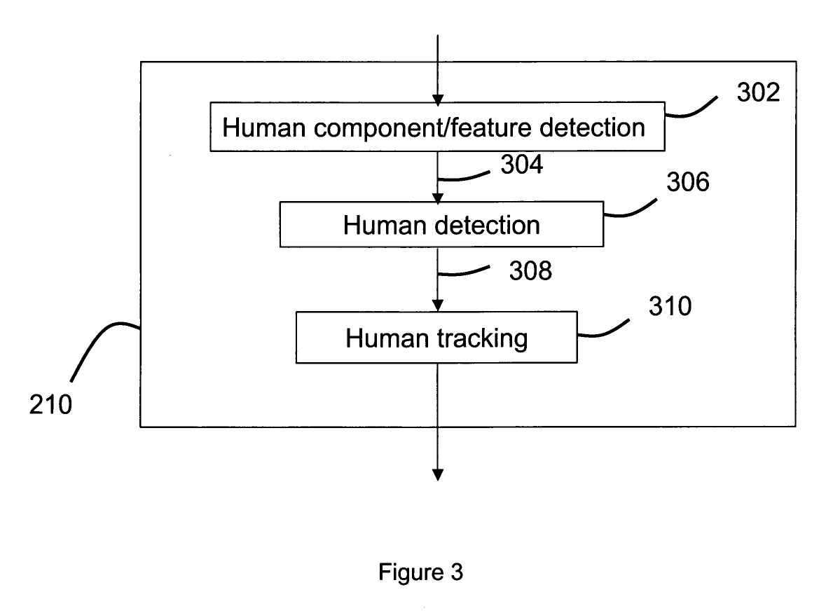

FIG. 3 depicts a conceptual block diagram of the human detection/tracking module 210, according to embodiments of the invention. First, the human component and feature detection 302 extracts and analyzes various object features 304. These features 304 may later be used by the human detection module 306 to detect if there is human object in the scene. Human models 308 may then be generated for each detected human. These detected human models 308 may be served as human observations at each frame for the human tracking module 310.

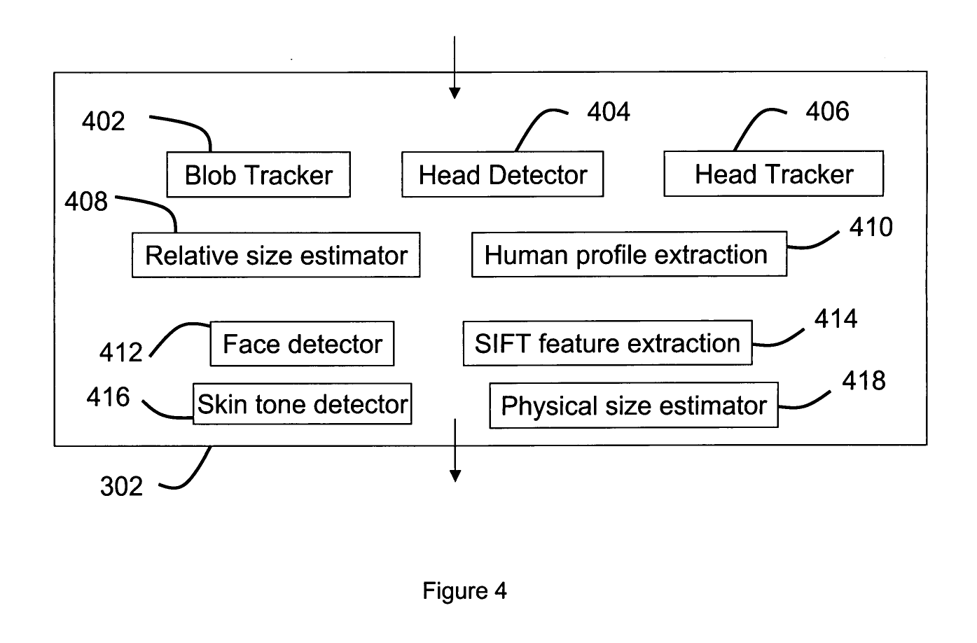

FIG. 4 lists exemplary components in the human component and feature extraction module 302 according to embodiments of the invention. Blob tracker 402 may perform blob based target tracking, where the basic target unit is the individual blobs provided by the foreground blob extraction module 206. Note that a blob may be the basic support of the human target; any human object in the frame resides in a foreground blob. Head detector 404 and tracker module 406 may perform human head detection and tracking. The existence of a human head in a blob may provide strong evidence that the blob is a human or at least probably contains a human. Relative size estimator 408 may provide the relative size of the target compared to an average human target. Human profile extraction module 410 may provide the number of human profiles in each blob by studying the vertical projection of the blob mask and top profile of the blob.

Face detector module 412 also may be used to provide evidence on whether a human exists in the scene. There are many face detection algorithms available to apply at this stage, and those described herein are embodiments and not intended to limit the invention. One of ordinary skill in the relevant arts would appreciate the application of other face detection algorithms based, at least, on the teachings provided herein. In this video human detection scenario, the foreground targets have been detected by earlier content analysis modules, and the face detection can only be applied on the input blobs, which may increase the detection reliability as well as reduce the computational cost.

The next module 414 may provide an image feature generation method called the scale invariant feature transform (SIFT) or extract SIFT features. A class of local image features may be extracted for each blob. These features are invariant to image scaling, translation, and rotation, and partially invariant to illumination changes and affine or three dimensional (3D) projection. These features may be used to separate rigid objects such as vehicles from non-rigid objects such as humans. For rigid objects, their SIFT features from consequent frames may provide much better match than that of non-rigid objects. Thus, the SIFT feature matching scores of a tracked target may be used as a rigidity measure of the target, which may be further used in certain target classification scenarios, for example, separate human group from vehicle.

Skin tone detector module 416 may detect some or all of the skin tone pixels in each detected head area. In embodiments of the invention, the ratio of the skin tone pixels in the head region may be used to detect best human snapshot. According to embodiments of the invention, a way to detect skin tone pixels may be to produce a skin tone lookup table in YCrCb color space through training. A large amount of image snapshot on the application scenarios may be collected beforehand. Next, ground truth upon which a skin tone pixel may be obtained manually. This may contribute to a set of training data, which may then be used to produce a probability map, where, according to an embodiment, each location refers to one YCrCb number and the value on that location may be the probability that the pixel with the YCrCb value is a skin tone pixel. A skin tone lookup table may be obtained by applying threshold on skin tone probability map, and any YCrCb value with a skin tone probability greater than a user controllable threshold may be considered as skin tone.

Similar to face detection, there are many skin tone detection algorithms available to apply at this stage, and those described herein are embodiments and not intended to limit the invention. One of ordinary skill in the relevant arts would appreciate the application of other skin tone detection algorithms based, at least, on the teachings provided herein.

Physical size estimator module 418 may provide the approximate physical size of the detected target. This may be achieved by applying calibration on the camera being used. There may be a range of camera calibration methods available, some of which are computationally intensive. In video surveillance applications, quick, easy and reliable methods are generally desired. In embodiments of the invention, a pattern-based calibration may serve well for this purpose. See, for example, Z. Zhang. A flexible new technique for camera calibration. IEEE Transactions on Pattern Analysis and Machine Intelligence, 22(11):1330-1334, 2000, which is incorporated herein in its entirety, where the only thing the operator needs to do is to wave a flat panel with a chessboard-like pattern in front of the video camera.

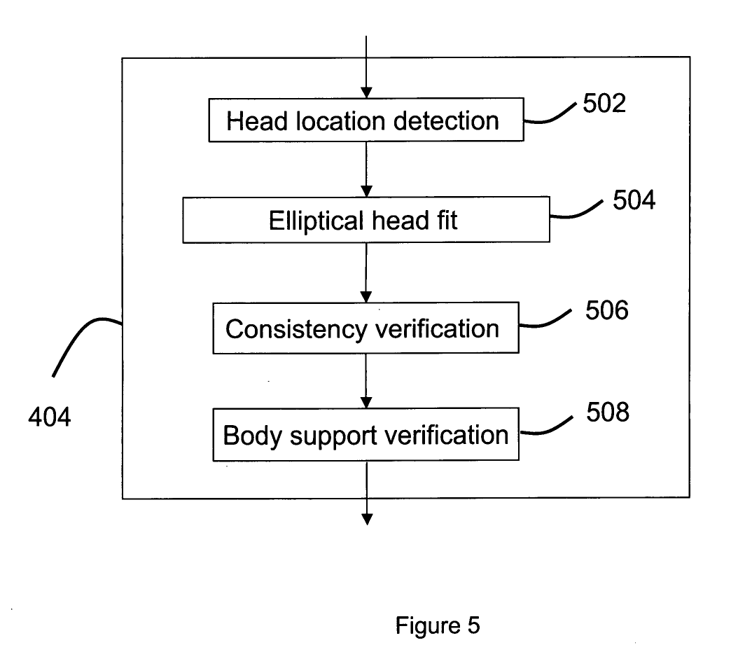

FIG. 5 depicts a block diagram of the human head detector module 404 according to embodiments of the invention. The input to the module 404 may include frame-based image data such as source video frames, foreground masks with different confidence levels, and segmented foreground blobs. For each foreground blob, the head location detection module 502 may first detect the potential human head locations. Note that each blob may contain multiple human heads, while each human head location may just contain at most one human head. Next, for each potential human head location, multiple heads corresponding to the same human object may be detected by an elliptical head fit module 504 based on different input data.

According to embodiments of the invention, an upright elliptical head model may be used for the elliptical head fit module 504. The upright elliptical head model may contain three basic parameters, which are neither a minimum or maximum number of parameters: the center point, head width which corresponds to the minor axis, and the head height which corresponds to the major axis. Further, the ratio between the head height and head width may be according to embodiments of the invention limited within a range of about 1.1 to about 1.4. In embodiments of invention, three types of input image masks may be used independently to detect the human head: the change mask, the definite foreground mask and the edge mask. The change mask may indicate all the pixels that may be different from the background model to some extend. It may contain both foreground object and other side effects caused by the foreground object such as shadows. The definite foreground mask may provide a more confident version of the foreground mask, and may remove most of the shadows pixels. The edge mask may be generated by performing edge detection, such as, but not limited to, Canny edge detection, over the input blobs.

The elliptical head fit module 504 may detect three potential heads based on the three different masks, and these potential heads may then be compared by consistency verification module 506 for consistency verification. If the best matching pairs are in agreement with each other, then the combined head may be further verified by body support verification module 508 to determine whether the pair have sufficient human body support. For example, some objects, such as balloons, may have human head shapes but may fail on the body support verification test. In further embodiments, the body support test may require that the detected head is on top of other foreground region, which is larger than the head region in both width and height measure.

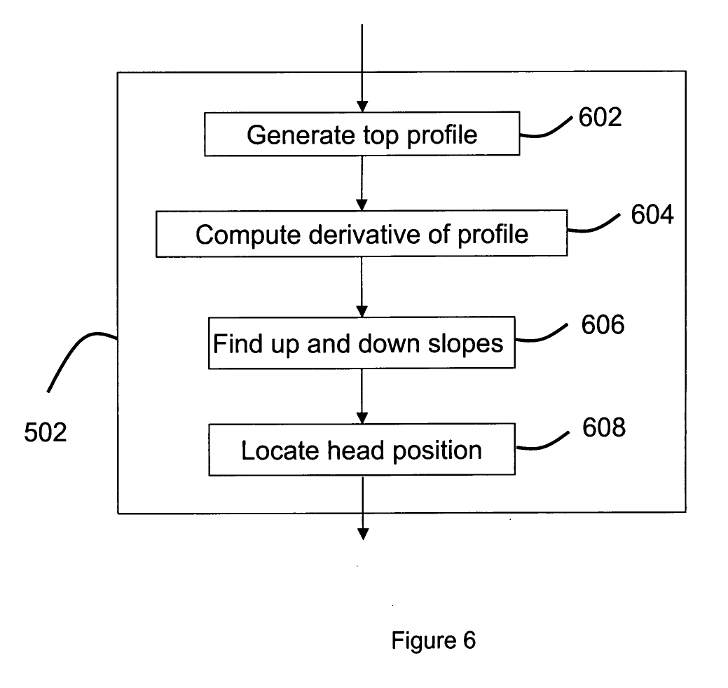

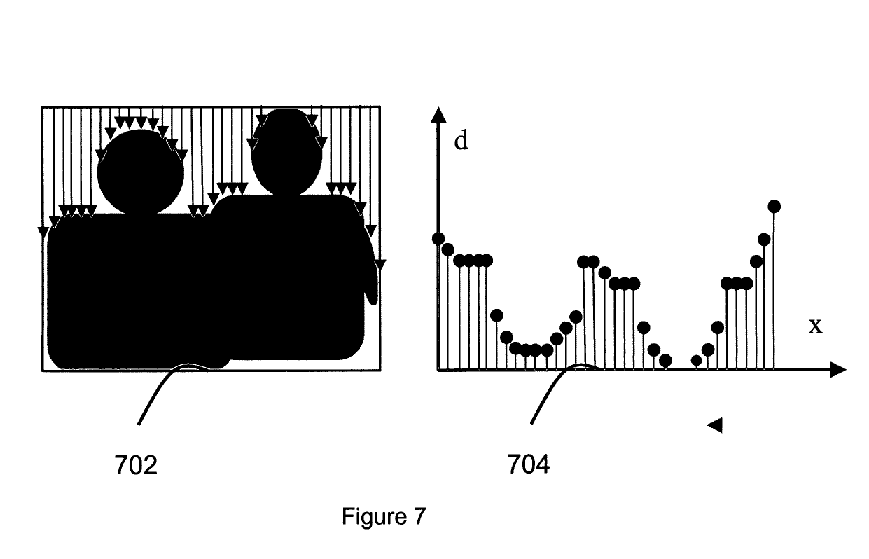

FIG. 6 depicts a conceptual block diagram of the head location detection module 502 according to embodiments of the invention. The input to the module 502 may include the blob bounding box and the one of the image masks. Generate top profile module 602 may generate a data vector from the image mask indicates the top profile of the target. The length of the vector may be the same as the width of the blob width. FIG. 7 illustrates an example of a target top profile according to embodiments of the invention. Frame 702 depicts multiple blob targets with various features and the top profile applied to determine the profile. Graph 704 depicts the resulting profile as a factor of distance.

Next, compute derivative or profile module 604 performs a derivative operation on the profile. Slope module 606 may detect some, most, any or all the up and down slope locations. In an embodiment of the invention, one up slope may be the place where the profile derivative is the local maximum and the value is greater than a minimum head gradient threshold. Similarly, one down slope may be the position where the profile derivative is the local minimum and value is smaller than the negative of the above minimum head gradient threshold. A potential head center may be between one up slope position and one down slope position where the up slope should be at the left side of the down slope. At least one side shoulder support may be required for a potential head. A left shoulder may be the immediate area to the left of the up slope position with positive profile derivative values. A right shoulder may be the immediate area to right of the up slope position with negative profile derivative values. The detected potential head location may be defined by a pixel bounding box. The left position if the minimum of the left shoulder position or the up slope position if no left shoulder may be detected. The right side of the bounding box may be the maximum of the right shoulder position or the down slope position if no right shoulder may be detected. The top may be the maximum profile position between the left and right edges of the bounding box, and the bottom may be the minimum profile position on the left and right edges. Multiple potential head locations may be detected in this module.

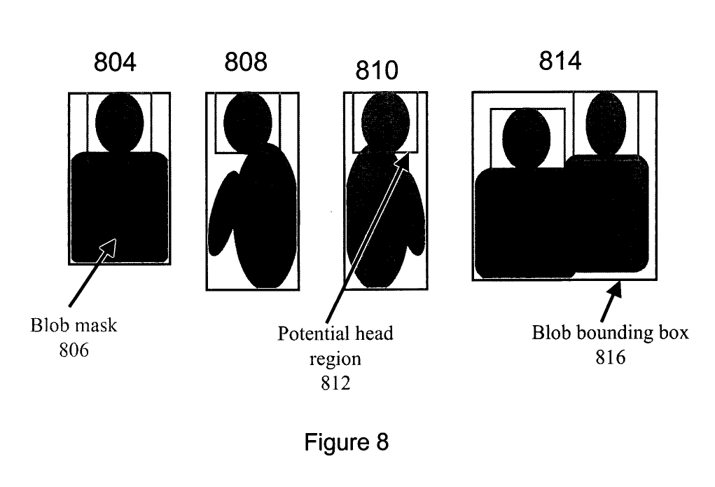

FIG. 8 shows some examples of detected potential head locations according to embodiments of the invention. Frame 804 depicts a front or rear-facing human. Frame 808 depicts a right-facing human, and frame 810 depicts a left facing human. Frame 814 depicts two front and/or rear-facing humans. Each frame includes a blob mask 806, at least one potential head region 812, and a blob bounding box 816.

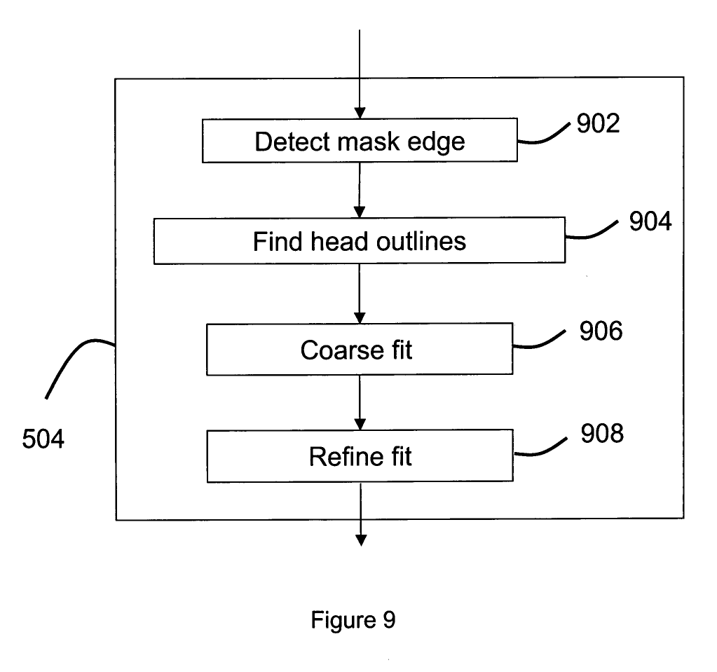

FIG. 9 depicts a conceptual block diagram of the elliptical head fit module 504 according to embodiments of the invention. The input to module 504 may include one of the above-mentioned masks and the potential head location as a bounding box. Detect edge mark module 902 may extract the outline edge of the input mask within the input bounding box. Head outline pixels are then extracted by find head outlines module 904. These points may then be used to estimate an approximate elliptical head model with coarse fit module 906. The head model may be further refined locally which reduce the overall fitting error to the minimum with the refine fit module 908.

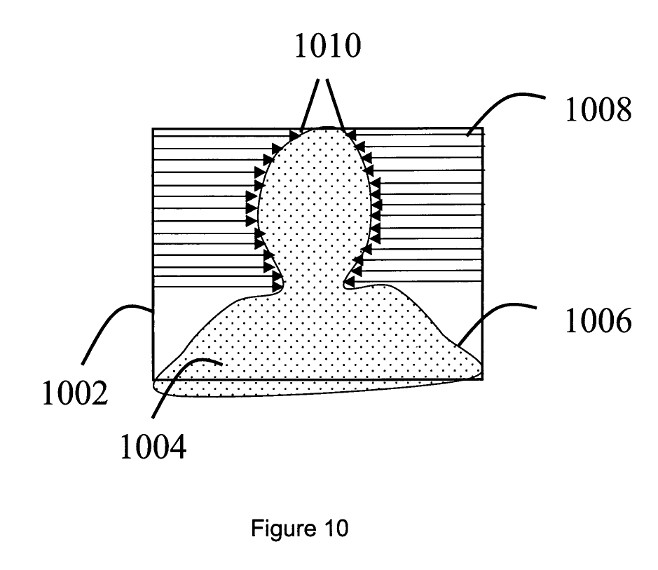

FIG. 10 illustrates the method on how to find the head outline pixels according to embodiments of the invention. The depicted frame may include a bounding box 1002 that may indicate the input bounding box of the potential head location detected in module 502, the input mask 1004, and the outline edge 1006 of the mask. The scheme may perform horizontal scan starting from the top of the bounding box from outside toward the inside as indicated by lines 1008. For each scan line, a pair of potential head outline points may be obtained as indicated by the tips of the arrows at points 1010. The two points may represent a slice of the potential head, which may be called head slice. To be considered as a valid head slice, the two end points may need to be close enough to the corresponding end points of the previous valid head slice. The distance threshold may be adaptive to the mean head width which may be obtained by averaging over the length of the detected head slices. For example, one fourth of the current mean head width may be chosen as the distance threshold.

Referring back to FIG. 9, the detected potential head outline pixels may be used to fit into an elliptical human head model. If the fitting error is small relative to the size of the head, the head may be considered as a potential detection. The head fitting process may consist of two steps: a deterministic coarse fit with the coarse fit module 906 followed by an iterative parameter estimation refinement with the refine fit module 908. In the coarse fit module 906, four elliptical model parameters may need to be estimated from the input head outline pixels: the head center position Cx and Cy, the head width Hw and the head height Hh. Since the head outline pixels come in pairs, the Cx may be the average of all the X coordinates of the outline pixels. Based on the basic property of the elliptical shape, the head width Hw may be approximated using the sum of the mean head slice length and the standard deviation of the head slice length. The approximate head height may be computed from the head width using the average human height to width ratio of 1.25. At last, given the above three elliptical parameters of the head center position Cx, the head width Hw, and the head height Hh, using the general formula of the elliptical equation, for each head outline point, an expected Y coordinate of the elliptical center may be obtained. The final estimation of the Cy may be the average of all of these expected Cy values.

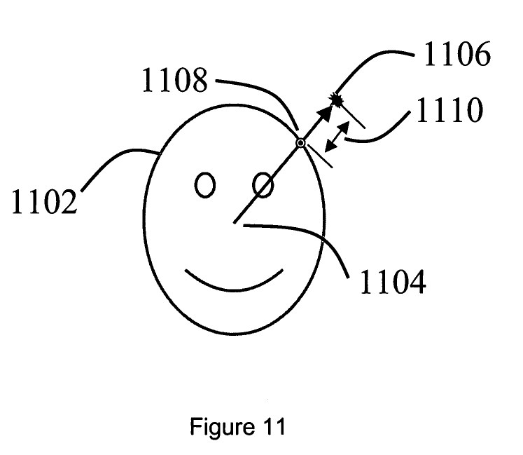

FIG. 11 illustrates the definition of the fitting error of one head outline point to the estimated head model according to embodiments of the invention. The illustration includes an estimated elliptical head model 1102 and a center of the head 1104. For one head outline point 1106, its fitting error to the head model 1110 may be defined as the distance between the outline point 1106 and the cross point 1108. The cross point 1108 may be the cross point of the head ellipse and the line determined by the center point 1104 and the outline point 1106.

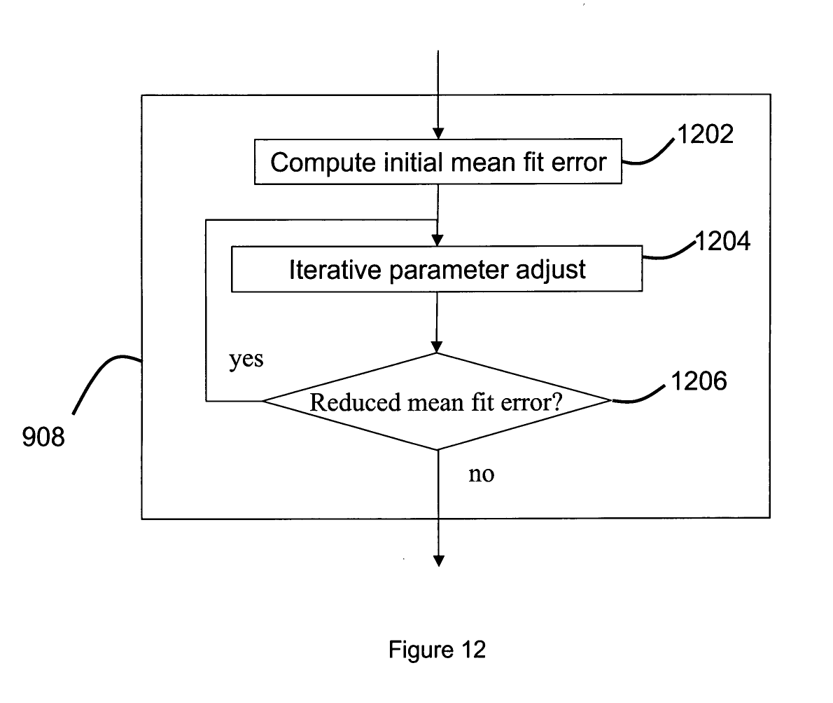

FIG. 12 depicts a conceptual block diagram of the refine fit module 908 according to embodiments of the invention. A compute initial mean fit error module 1202 may compute the mean fit error of all the head outline pixels on the head model obtained by the coarse fit module 906. Next, in an iterative parameter adjustment module 1204, small adjustments may be made for each elliptical parameter to determine whether the adjusted model would decrease the mean fit error. One way to choose the adjustment value may be to use the half of the mean fit error. The adjustment may be made for both directions. Thus in each iteration, eight adjustments may be tested and the one produces the smallest mean fit error will be picked. A reduced mean fit error module 1206 may compare the mean fit error before and after the adjustment, if the fit error is not reduced, the module may output the refined head model as well as the final mean fit error; otherwise, the flow may go back to 1204 to perform the next iteration of the parameter refinement.

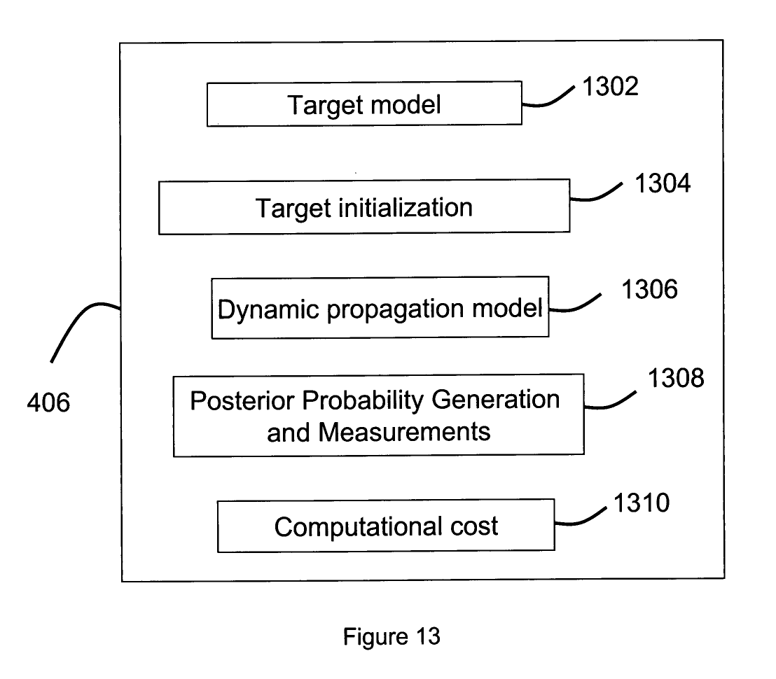

FIG. 13 lists the exemplary components of the head tracker module 406 according to embodiments of the invention. The head detector module 404 may provide reliable information for human detection, but may require that the human head profile may be visible in the foreground masks and blob edge masks. Unfortunately, this may not always be true in real situations. When part of the human head is very similar to the background or the human head is occluded or partially occluded, the human head detector module 404 may have difficulty to detect the head outlines. Furthermore, any result based on a single frame of the video sequence may be usually non-optimal.

In embodiments of the invention, a human head tracker taking temporal consistence into consideration may be employed. The problem of tracking objects through a temporal sequence of images may be challenging. In embodiments, filtering, such as Kalman filtering, may be used to track objects in scenes where the background is free of visual clutter. Additional processing may be required in scenes with significant background clutter. The reason for this additional processing may be the Gaussian representation of probability density that is used by Kalman filtering. This representation may be inherently uni-modal, and therefore, at any given time, it may only support one hypothesis as to the true state of the tracked object, even when background clutter may suggest a different hypothesis than the true target features. This limitation may lead Kalman filtering implementations to lose track of the target and instead lock onto background features at times for which the background appears to be a more probable fit than the true target being tracked. In embodiments of the invention with this clutter, the following alternatives may be applied.

In one embodiment, the solution to this tracking problem may be the application of a CONDENSATION (Conditional Density Propagation) algorithm. The CONDENSATION algorithm may address the problems of the Kalman filtering by allowing the probability density representation to be multi-modal, and therefore capable of simultaneously maintaining multiple hypotheses about the true state of the target. This may allow recovery from brief moments in which the background features appear to be more target-like (and therefore a more probable hypothesis) than the features of the true object being tracked. The recovery may take place as subsequent time-steps in the image sequence provide reinforcement for the hypothesis of the true target state, while the hypothesis for the false target may not reinforced and therefore gradually diminishes.

Both the CONDENSATION algorithm and the Kalman filtering tracker may be described as processes which propagate probability densities for moving objects over time. By modeling the dynamics of the target and incorporating observations, the goal of the tracker may be to determine the probability density for the target's state at each time-step, t, given the observations and an assumed prior density. The propagation may be thought of as a three-step process involving drift, diffusion, and reactive reinforcement due to measurements. The dynamics for the object may be modeled with both a deterministic and a stochastic component. The deterministic component may cause a drift of the density function while the probabilistic component may increase uncertainty and therefore may cause spreading of the density function. Applying the model of the object dynamics may produce a prediction of the probability density at the current time-step from the knowledge of the density at the previous time step. This may provide a reasonable prediction when the model is correct, but it may be insufficient for tracking because it may not involve any observations. A late or near-final step in the propagation of the density may be to account for observations made at the current time-step. This may be done by way of reactive reinforcement of the predicted density in the regions near the observations. In the case of the uni-modal Gaussian used for the Kalman filter, this may shift the peak of the Gaussian toward the observed state. In the case of the CONDENSATION algorithm, this reactive reinforcement may create peaking in the local vicinity of the observation, which leads to multi-modal representations of the density. In the case of cluttered scenes, there may be multiple observations which suggest separate hypotheses for the current state. The CONDENSATION algorithm may create separate peaks in the density function for each observation and these distinct peaks may contribute to robust performance in the case of heavy clutter.

Like the embodiments of the invention employing Kalman filtering tracker described elsewhere herein, the CONDENSATION algorithm may be modified for the actual implementation, in further or alternative embodiments of the invention, because detection is highly application dependent. Referring to FIG. 13, the CONDENSATION tracker may generally employ the following factors, where alternative and/or additional factors will be apparent to one of ordinary skill in the relevant art, based at least on the teachings provided herein:

1. The modeling of the target or the selection of state vector x 1302

2. The target states initialization 1304

3. The dynamic propagation model 1306

4. Posterior probability generation and measurements 1308

5. Computational cost considerations 1310

In embodiments, the head tracker module may be a multiple target tracking system, which is a small portion of the whole human tracking system. The following exemplary embodiments are provided to illustrate the actual implementation and are not intended to limit the invention. One of ordinary skill would recognize alternative or additional implementations based, at least, on the teachings provided herein.

For the target model factor 1302, the CONDENSATION algorithm may be specifically developed to track curves, which typically represent outlines or features of foreground objects. Typically, the problem may be restricted to allowing a low-dimensional parameterization of the curve, such that the state of the tracked object may be represented by a low-dimensional parameter x. For example, the state x may represent affine transformations of the curve as a non-deformable whole. A more complex example may involve a parameterization of a deformable curve, such as a contour outline of a human hand where each finger is allowed to move independently. The CONDENSATION algorithm may handle both the simple and the complex cases with the same general procedure by simply using a higher dimensional state, x. However, increasing the dimension of the state may not only increase the computational expense, but also may greatly increase the expense of the modeling that is required by the algorithm (the motion model, for example). This is why the state may be typically restricted to a low dimension. Due to the above reason, three states for the head tracking, the center location of the head Cx and Cy and the size of the head represented by the minor axis length of the head ellipse model. The two constraints that may be used are that the head is always in upright position and the head has a fixed range of aspect ratio. Experimental results show that these two constrains may be reasonable when compared to actual data.

For the target initialization factor 1304, due to the background clutter in the scene, most existing implementations of the CONDENSATION tracker manually select the initial states for the target model. For the present invention, the head detector module 404 may perform automatic head detection for each video frame. Those detected heads may be existing human heads being tracked by different human trackers, or newly detected human heads. Temporal verification may be performed on these newly detected heads and initialize the head tracking module 310 and starting additional automatic tracking once a newly detected head passes the temporal consistency verification.

For the dynamic propagation model factor 1306, a conventional dynamic propagation model may be a linear prediction combined with a random diffusion as described in the formula (1) and (2):

xₜ− x̅ₜ^{′}=A*(xₜ₋₁− x̅ₜ₋₁)+B*wₜ (1)

x̅ₜ^{′}=f( x̅ₜ₋₁, x̅ₜ₋₁, . . . ) (2)

where f(*) may be an Kalman filter or normal IIR filter, parameters A and B represent the deterministic and stochastic components of the dynamical model, and wₜ is a normal Gaussian. The uncertainty from f(*) and wₜ is the major source of performance limitation. More samples may be needed to offset this uncertainty, which may increase the computational cost significantly. In the invention, a mean-shift predictor may be used to solve the problem. In embodiments, the mean-shift tracker may be used to track objects with distinguish color. The performance may be limited by the fact that assumptions are made that the target has different color from its surrounding background, which may not always be true. But in the head tracking case, a mean-shift predictor may be used to get the approximate location of the head thus may significantly reduce the number of sample required but with better robustness. The mean-shift predictor may be employed to estimate the exact location of the mean of the data by determining the shift vector from initial mean given data points and may approximate location of the mean of this data. In the head tracking case, the data points may refer to the pixels in a head area, the mean may refer to the location of the head center and the approximate location of the mean may be obtained from the dynamic model f(*) which may be a linear prediction.

For the posterior probability generation and measurements factor 1308, the posterior probabilities needed by the algorithm for each sample configuration may be generated by normalizing the color histogram match and head contour match. The color histogram may be generated using all the pixels within the head ellipse. The head contour match may be the ratio of the edge pixels along the head outline model. The better the matching score, the higher the probability of the sample overlap with the true head. The probability may be normalized such that the perfect match has the probability of 1.

For the computational cost factor 1310, in general, both the performance and the computational cost may be in proportion to the number of samples used. In stead of choosing a fixed number of samples, we may fix the sum of posterior probabilities may be fixed such that the number of samples may vary based on the tracking confidence. When at high confident moment, we may see more good matching samples may be obtained, thus fewer samples may be needed. On the other hand, when tracking confidence is low, the algorithm may automatically use more samples to try to track through. Thus, the computational cost may vary according to the number of targets in the scene and how tough to tracking those targets. With the combination of the mean-shift predictor and the adaptive sample number selection, real-time tracking of multiple heads may be easily achieved without losing tracking reliabilities.

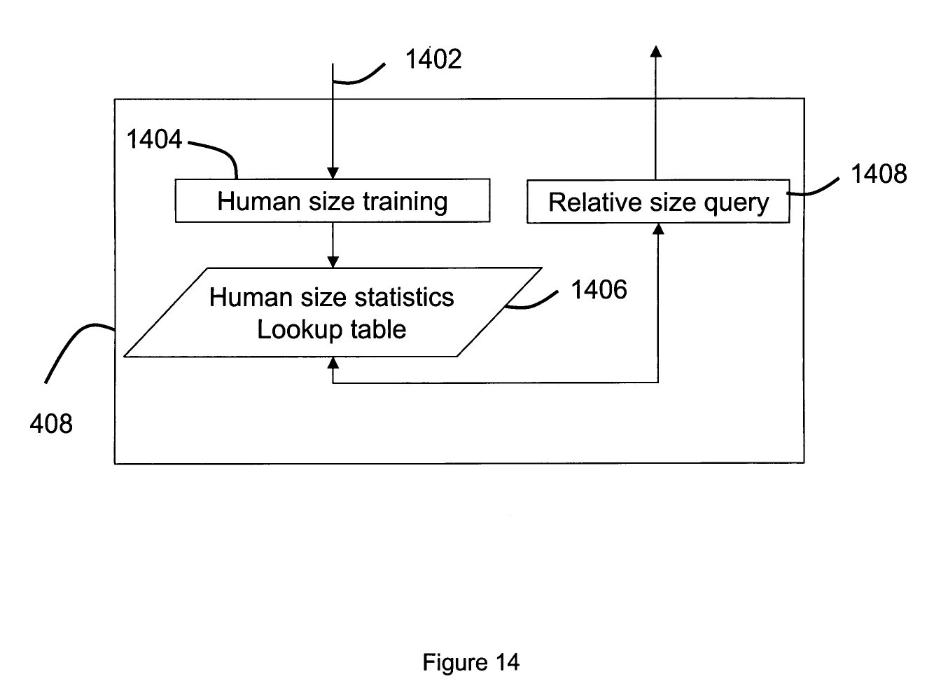

FIG. 14 depicts a block diagram of the relative size estimator module 408 according to embodiments of the invention. The detected and tracked human target may be used as data input 1402 to the module 408. The human size training module 1404 may chose one or more human target instances, such as those deemed to have a high degree of confidence, and accumulate human size statistics. The human size statistic is actually a look up table module 1406 may store the average human height, width and image area data for every pixel location on the image frame. The statistic update may be performed once for every human target after it disappears, thus maximum confidence may be obtained on the actual type of the target. The footprint trajectory may be used as the location indices for the statistical update. Given that there may be inaccuracy on the estimation of the footprint location and the fact that target are likely to have similar size in neighborhood regions, both the exact footprint location and its neighborhood may be updated using the same instant human target data. With a relative size query module 1408, when detecting a new target, its relative size to an average human target may be estimated by enquiring from the relative size estimator using the footprint location as the key. The relative size query module 1408 may return the values when there have been enough data points on the enquired location.

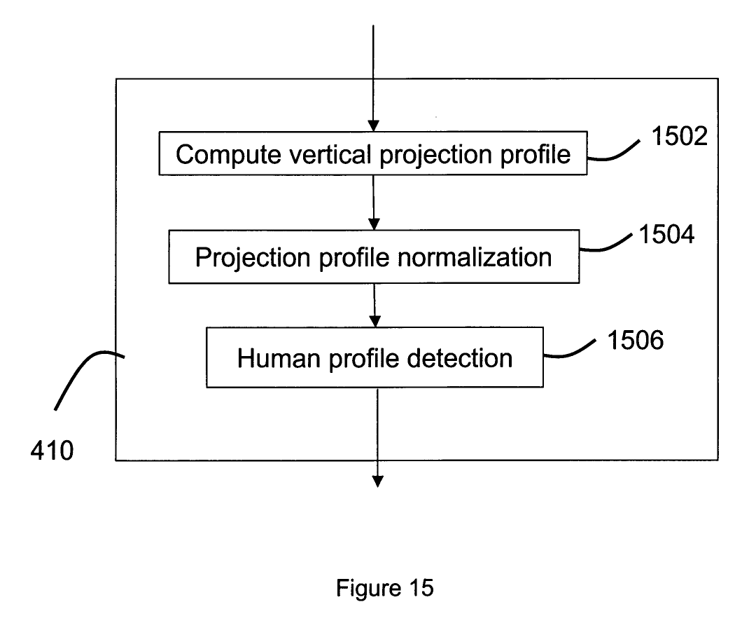

FIG. 15 depicts a conceptual block diagram of the human profile extraction module 410 according to embodiments of the invention. First, block 1502 may generate the target vertical projection profile. The projection profile value for a column may be the total foreground pixel numbers on that column in the input foreground mask. Next, the projection profile may be normalized in projection profile normalization module 1504 that the maximum value may be 1. Last, with the human profile detection module 1506, the potential human shape project profile may be extracted by searching the peaks and valleys on the projection profile 1506.

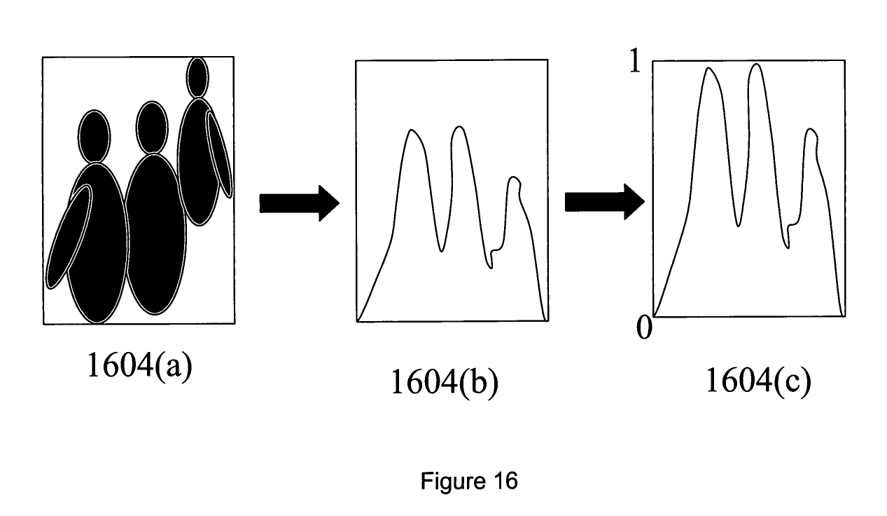

FIG. 16 shows an example of human projection profile extraction and normalization according to the embodiments of the invention. 1604(a) illustrates the input blob mask and bounding box. 1604(b) illustrates the vertical projection profile of the input target. 1604(c) illustrates the normalized vertical projection profile.

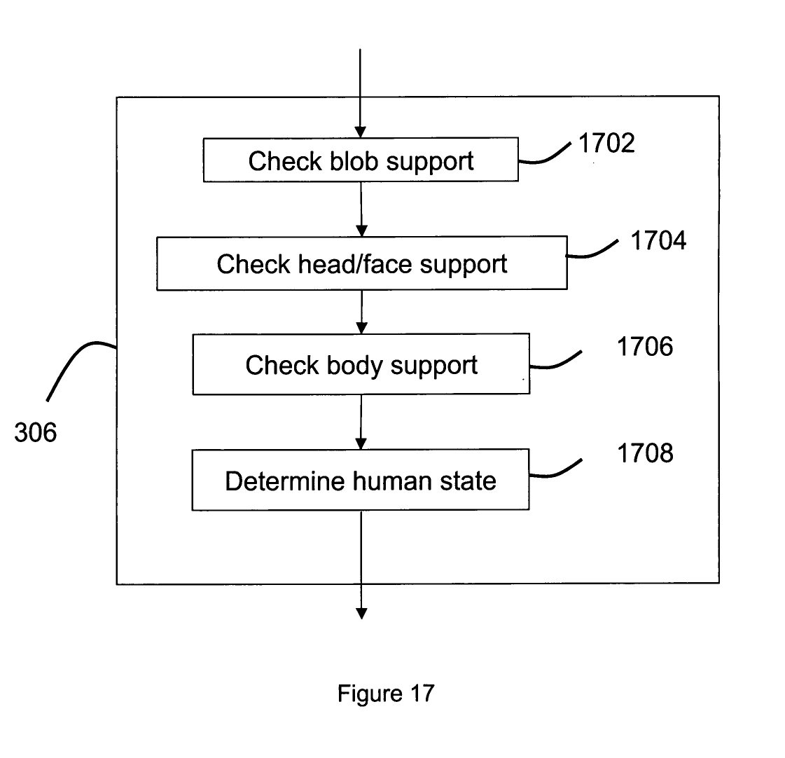

FIG. 17 depicts a conceptual block diagram of the human detection module 306 according to embodiments of the invention. First, the check blob support module 1702 may check if the target has blob support. A potential human target may have multiple levels of supports. The very basic support is the blob. In other words, a human target can only exist in a certain blob which is tracked by the blob tracker. Next, the check head and face support module 1704 may check if there is human head or face detected in the blob, either human head or human face may be strong indicator of a human target. Third, the check body support module 1706 may further check if the blob contains human body. There are several properties that may be used as human body indicators, including, for example:

1. Human blob aspect ratio: in non-overhead view cases, human blob height may be usually much large than human blob width;

2. Human blob relative size: the relative height, width and area of a human blob may be close to the average human blob height, width and area at each image pixel location.

3. Human vertical projection profile: every human blob may have one corresponding human projection profile peak.

4. Internal human motion: moving human object may have significant internal motion which may be measured by the consistency of the SIFT features.

Last, the determine human state module 1708 determines whether the input blob target is a human target and if yes what its human state is.

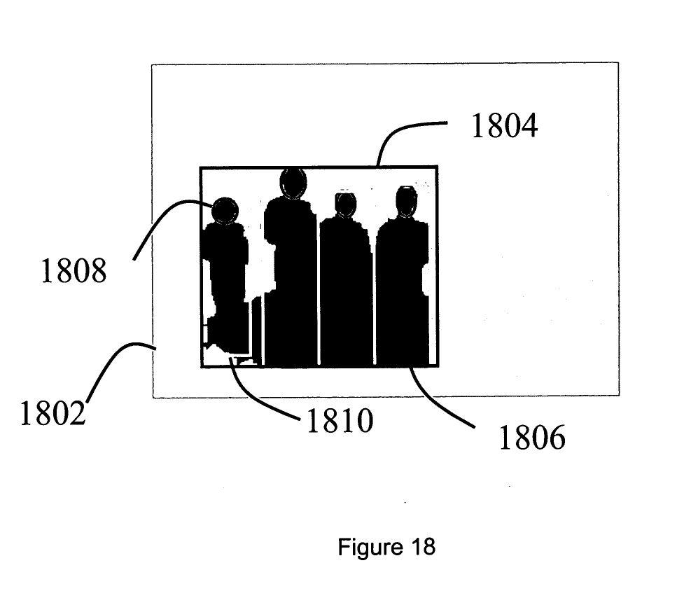

FIG. 18 shows an example of different levels of human feature supports according to the embodiments of the invention. FIG. 18 includes a video frame 1802, the bounding box 1804 of a tracked target block, the foreground mask 1806 of the same blob, and a human head support 1810. In the shown example, there may be four potential human targets, and all have the three levels of human feature supports.

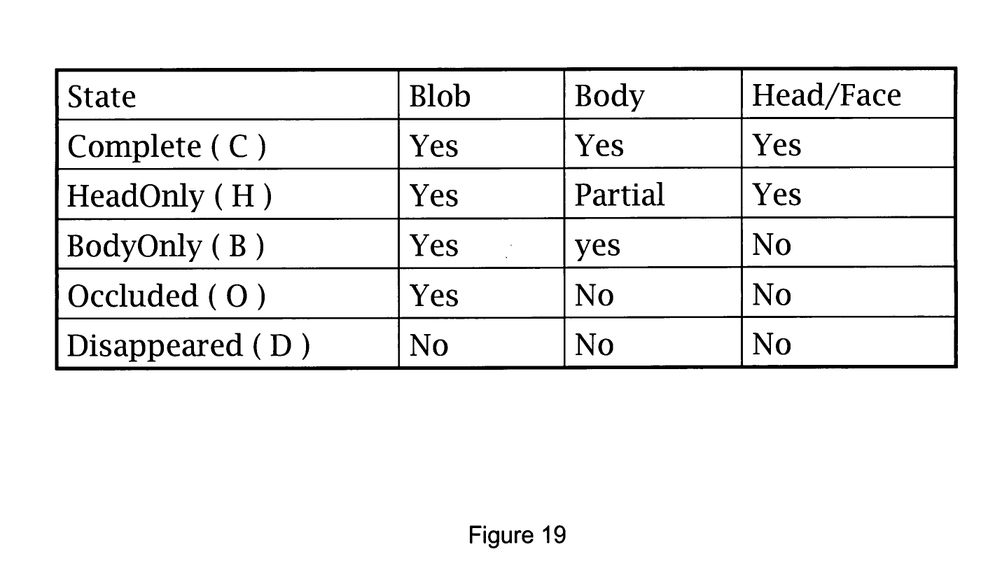

FIG. 19 lists the potential human target states that may used by the human detection and tracking module 210, according to the embodiments of the invention. A “Complete” human state indicates that both head/face and human body are detected. In other word, the target may have all of the “blob”, “body” and “head” supports. The example in FIG. 18 shows four “Complete” human targets. A “HeadOnly” human state refers to the situation that human head or face may be detected in the blob but only partial human body features may be available. This may correspond to the scenarios that the lower part of a human body may be blocked or out of the camera view. A “BodyOnly” state refers to the cases that human body features may be observed but no human head or face may be detected in the target blob. Note that even there may be no human face or head may be detected in the target blob, if all the above features are detected, the blob may still be considered as a human target. An “Occluded” state indicates that the human target may be merged with other targets and no accurate human appearance representation and location may be available. A “Disappeared” state indicates that the human target may already have left the scene.

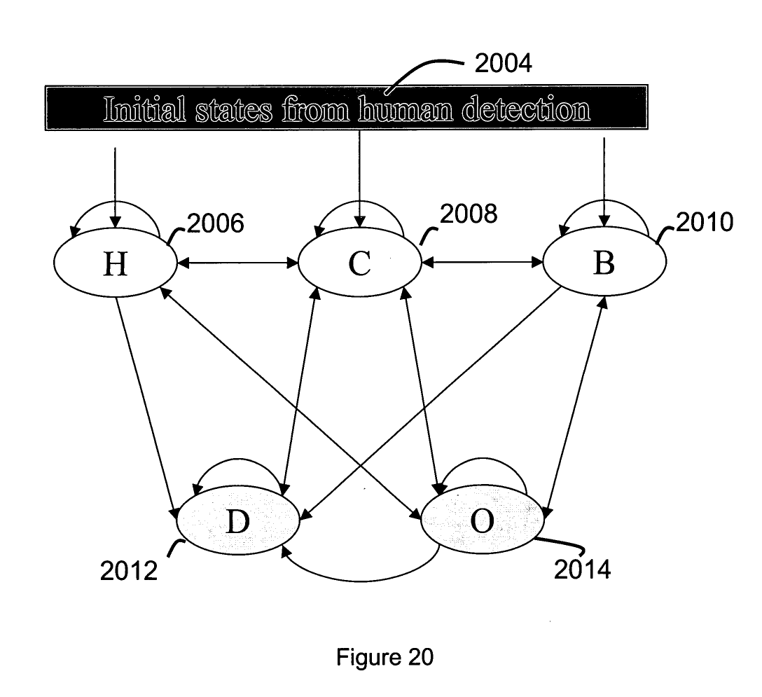

FIG. 20 illustrates the human target state transfer diagram according to the embodiments of the invention. This process may be handled by the human detection and tracking module 210. This state transfer diagram includes five states, with at least states 2006, 2008, and 2010 connected to the initial states 2004: states HeadOnly 2006, Complete 2008, BodyOnly 2010, Disappeared 2012, and Occluded 2014 are connected to each other and also to themselves. When a human target created, it may be at one of the three human states: Complete, HeadOnly or BodyOnly. The state to state transfer is mainly based on the current human target state and the human detection may result on the new matching blob, which may be described as follows:

If current state is “HeadOnly”, the next state may be:

“HeadOnly”: has matching face or continue head tracking;

“Complete”: in addition to the above, detect human body;

“Occluded”: has matching blob but lost head tracking and matching face;

“Disappeared”: lost matching blob.

If the current state is “Complete”, the next state may be:

“Complete”: has matching face or continue head tracking as well as the detection of human body;

“HeadOnly”: lost human body due to blob merge or background occlusion;

“BodyOnly”: lost head tracking and matching face detection;

“Occluded”: lost head tracking, matching face, as well as human body support, but still has matching blob;

“Disappeared”: lost everything, even the blob support.

If the current state is “BodyOnly”, the next state may be:

“Complete”: detected head or face with continued human body support;

“BodyOnly”: no head or face detected but with continued human body support;

“Occluded”: lost human body support but still has matching blob;

“Disappeared”: lost both human body support and the blob support;

If the current state is “Occluded”, the next state may be:

“Complete”: got a new matching human target blob which has both head/face and human body support;

“BodyOnly”: got a new matching human target blob which has human body support;

“HeadOnly”: got a matching human head/face in the matching blob;

“Occluded”: No matching human blob but still has correspond blob tracking;

“Disappeared”: lost blob support.

If the current state is “Disappeared”, the next state may be:

“Complete”: got a new matching human target blob which has both head/face and human body support;

“Disappeared”: still no matching human blob.

Note that “Complete” state may indicate the most confident human target instances. The overall human detection confidence measure on a target may be estimated using the weighted ratio of number of human target slices over the total number of target slices. The weight of “complete” human slice may be twice as much as the weight on “HeadOnly” and “BodyOnly” human slices. For a high confidence human target, its tracking history data, especially those target slices with “Complete” or “BodyOnly” slices may be used to train the human size estimator module 408.

With the head detection and human model described above, more functionality may be provided by the system such as the best human snapshot detection. When a human target triggers an event, the system may send out an alert with a clear snapshot of the target. One snapshot, according to embodiments of the invention, may be the one that the operator can obtain the maximum amount of the information about the target. To detect the human snapshot or what may be called the best available snapshot or best snapshot, the following metrics may be examined:

1. Skin tone ration in head region: the observation that the frontal view of a human head usually contains more skin tone pixels than that of back view, also called a rear-facing view, may be used. Thus a higher head region skin tone ratio may indicate a better snapshot.

2. Target trajectory: from the footprint trajectory of the target, it may be determined if the human is moving towards or away from the camera. Moving towards the camera may provide a much better snapshot than moving away from the camera.

3. Size of the head: the bigger the image size of the human head, the more details the image might may provide on the human target. The size of the head may be defined as the mean of the major and minor axis length of the head ellipse model.

A reliable best human snapshot detection may be obtained by jointly consider the above three metrics. One way is to create a relative best human snapshot measure on any two human snapshots, for example, human1 and human2:

R=Rs*Rt*Rh, where

Rs is the head skin tone ratio of human 2 over the head skin tone ratio of human 1;

Rt equals one if the two targets are moving on the same relative direction toward the camera; equals 2 if human 2 moves toward the camera while human 1 moves away from the camera; and equals 0.5 if human 2 moves away from the camera while human 1 moves toward the camera;

Rh is the head size of human 2 over the head size of human 1.

Human 2 may be considered as a better snapshot if R is greater than one. In the system, for the same human target, the most recent human snapshot may b continuously compared with the best human snapshot at that time. If the relative measure R is greater than one, the best snapshot may be replaced with the most recent snapshot.

Another new capability is related to the privacy. With accurate head detection, alert images on the human head/face may be digitally obscured to protect privacy while giving operator visual verification of the presence of a human. This is particularly useful in the residential application.

With the human detection and tracking describe above, the system may provide an accurate estimation on how many human targets may exist in the camera view at any time of interest. The system may make it possible for the users to perform more sophisticated analysis such as, for example, human activity recognition, scene context learning, as one of ordinary skill in the art would appreciate based, at least, on the teachings provided herein.

The various modules discussed herein may be implemented in software adapted to be stored on a computer-readable medium and adapted to be operated by or on a computer, as defined herein.

All exampled discussed herein are non-limiting and non-exclusive examples, as would be understood by one of ordinary skill in the relevant art(s), based at least on the teachings provided herein.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above-described exemplary embodiments, but should be defined only in accordance with the following claims and their equivalents.

1. A computer-based system for performing scene content analysis for human detection and tracking, comprising:
a video input to receive a video signal;
a content analysis module, coupled to the video input, to receive the video signal from the video input, and analyze scene content from the video signal and determine an event from one or more objects visible in the video signal;
a data storage module to store the video signal, data related to the event, or data related to configuration and operation of the system; and
a user interface module, coupled to the content analysis module, to allow a user to configure the content analysis module to provide an alert for the event, wherein, upon recognition of the event, the content analysis module produces the alert.

2. The system of claim 1, wherein the event corresponds to the detection of data related to a human target or movements of the human target in the video signal.

3. The system of claim 1, wherein the content analysis module comprises:
a motion and change detection module to detect motion or a change in the motion of the one or more objects in the video signal, and determine a foreground from the video signal;
a foreground blob extraction module to separate the foreground into one or more blobs; and
a human detection and tracking module to determine one or more human targets from the one or more blobs.

4. The system of claim 3, wherein the human detection and tracking module comprises:
a human component and feature detection module to map the one or more blobs and determine whether one or more object features include human components:
a human detection module to receive data related to the one or more object features that are determined to include human components, and generate one or more human models from the data; and
a human tracking module to receive data relating to the one or more human models and track the movement of one or more of the one or more human models.

5. The system of claim 4, wherein the human component and feature detection module comprises:
a blob tracker module to track the one or more blobs;
a head detector module to detect a human head in said tracked one or more blobs;
a head tracker module to track the detected human head;
a relative size estimator module to provide a relative size of said tracked one or more blobs compared to an average human target;
a human profile extraction module to extract a number of human profiles in said tracked one or more blobs;
a face detector module to detect whether a human face exists in said detected human head; and
a scale invariant feature transform (SIFT) module to extract scale invariant features for said tracked one or more blobs.

6. The system of claim 5, wherein the head detector module comprises:
a head location detection module to detect a potential human head in said tracked one or more blobs;
an elliptical head fit module to detect multiple heads corresponding to the same object as said potential human head;
a consistency verification module to compare said detected multiple heads for consistency and identify a best matching pair of heads; and
a body support verification module to determine whether said best matching pair of heads has sufficient body support to be a human head.

7. The system of claim 6, wherein the head location detection module comprises:
a generate top profile module to identify a top profile of said tracked one or more blobs;
a compute derivative module to perform a derivative operation on said top profile;
a slope module to identify at least one slope in said derivative; and
a head position locator module to locate a potential human head based on said top profile and said slope.

8. The system of claim 6, wherein the elliptical head fit module comprises:
a mask edge detector module to receive at least one input image mask and a bounding box containing at least one potential human head as inputs and to extract an outline edge of said input image mask within said bounding box;
a head outlines determiner module to extract head outline pixels from the outline edge;
a coarse fit module to approximate an elliptical head model from the head outline pixels; and
a refined fit module to refine the elliptical head model and reduce an overall fitting error to a minimum value.

9. The system of claim 8, wherein the refined fit module comprises:
an initial mean fit error module to compute the mean fit error of all the head outline pixels on the elliptical head model obtained by the coarse fit module; and
an adjustment module to make adjustments for each elliptical parameter to determine whether the adjusted model would decrease the mean fit error.

10. The system of claim 5, wherein the head tracker module comprises:
a target model module to track curves in said detected human head;
a target initialization module to select initial states for a head target model;
a dynamic propagation model module to obtain an approximate location of said detected human head;
a posterior probability generation and measurement module to generate posterior probabilities for each sample configuration; and
a computational cost module to determine a number of samples needed to generate said posterior probabilities.

11. The system of claim 5, wherein the relative size estimator module comprises:
a human size training module to chose one or more human target instances and accumulate human size statistics;
a human size statistics lookup module to store and look up an average human height, width and image area data for every pixel location on an image frame; and
a relative size query module to estimate a relative size of a new target to an average human target.

12. The system of claim 5, wherein the human profile extraction module comprises;
a vertical projection profile module to generate a target vertical projection profile of a human profile;
a vertical projection profile normalizer module to normalize the target vertical projection profile over said number of extracted human profiles; and
a human profile detector module to extract a potential human shape project profile by searching peaks and valleys in the target vertical projection profile.

13. The system of claim 4, wherein the human detection module comprises:
a check blob support module to check if an input target has blob support;
a check head and face support module to check if there is human head or face detected in the input blob target;
a check body support module to check if the input blob target contains a human body; and
a human state determiner module to check whether the input blob target is a human target, and if so, to determine the human state of the human target.
